(19) United States
(12) Patent Application Publication
(10) Pub. No.: US 2026/0196395 A1
(43) Pub. Date: Jul. 9, 2026

(54) AUXILIARY POWER SUPPLY OF EQUIPMENT ON HIGH POTENTIAL

(71) Applicant: SCIBREAK AB, Jãrfälla (SE)

(72) Inventors: Lennart ÄNGQUIST, Enköping (SE); Tomas MODÉER, Stockholm (SE); Simon NEE, Upplands Väsby (SE)

(73) Assignee: SCIBREAK AB, Jãrfälla (SE)

(21) Appl. No.: 18/868,643

(22) PCT Filed: Jun. 2, 2023
(86) PCT No.: PCT/SE2023/050553

§ 371 Date: Nov. 22, 2024

Related U.S. Application Data
(60) Provisional application No. 63/365,834, filed on Jun. 3, 2022.

(51) Int. Cl. H01F 3/14; H01F 27/02; H01F 27/26; H01F 27/32; H01F 27/38; H01F 27/40; H02M 3/22

(52) U.S. Cl. CPC H01F 3/14; H01F 27/02; H01F 27/263; H01F 27/324; H01F 27/38; H01F 27/40; H02M 3/22

(57) ABSTRACT

A magnetic structure (60) comprises input and output stages (61, 62) comprising a yoke (61c, 62c) and at least two cores (61a, 62a), and at least one intermediate stage (63) with cores (63a) magnetically coupled to the input and output stages. By providing gaps (64) with magnetic permeability and high electrical voltage withstand capability providing magnetic coupling between the stages, poles (61d, 62d, 63d), which expand the cross-area of the cores, wherein the poles from adjacent stages are provided on opposing sides of the gaps (64), thereby providing magnetic coupling across the gaps (64), and windings (61b, 62b, 63b) provided on the cores, a transformer with extremely high is provided.

### TECHNICAL FIELD

The present invention deals with equipment and a method to supply auxiliary electrical power from a power source on ground to power consuming equipment close to or in galvanic contact with high voltage installations. High voltage systems in this context may be ac or de transmission systems having rated operating voltages in the range 50 kV to 800 kV. The power level for the auxiliary power to be transferred from ground to high voltage potential may be tens of watts to several kilowatts. The equipment is a transformer having very high insulation between primary and secondary windings operating with high frequency in the range from a few kilohertz up to hundreds of kilohertz.

### BACKGROUND ART

Measuring and control equipment on high potential typically has low power need, equal to or less than a few watts. These needs may be met by auxiliary power supply systems with limited power capability, e.g., systems using optical power supplied by fibre.

Switching equipment like circuit-breakers and disconnectors, on the other hand, needs much more energy, in the range of kilojoules per switching operation, and typically uses mechanical actuators on ground and transfer of the mechanical movement through insulating mechanical links, like pushrods or swingarms, to the moving contact(s) in the switch. The moving mass using this approach becomes substantial and the operating time between command to open and contact separation becomes long.

It was proposed already many decades ago to locate the actuator close to, and at the same potential as, the moving contact to shorten the operating time of circuit-breakers. A typical arrangement is to establish a local energy storage on high potential to provide the required electrical energy to the local actuator. Such a storage must be charged with energy supplied from ground potential. The invention deals with equipment for this purpose.

### SUMMARY OF INVENTION

The present invention is a magnetic transformer having extremely high insulation between its primary and secondary windings. Thus, a magnetic loop structure is provided, which allows magnetic flux to circulate through both sending and receiving windings. The magnetic structure has one or several gaps filled by insulating material with high voltage withstand capability, such as epoxy, polyurethan, silicon or other polymeric materials. The insulation may consist of solid insulating discs and/or cast material. Oil or gas may also be used as insulating material.

When the insulation shall withstand several hundred kilovolts the necessary gap length would be several centimetres. According to the invention such a transformer may be implemented if:
the total gap length is split into several smaller gaps along the magnetic path,
the magnetic structure is provided by area-expanding poles, facing each other on either side of the insulating layer in the gaps,
distributed reactive power is supplied by capacitors along the magnetic loop, and
the transformer operates with frequency somewhere in the range 1 kHz to 300 KHz

The transformer has quite small capacitance between its primary and secondary windings, typically in the range of picofarads.

An object of the present invention is to provide a magnetic transformer having extremely high insulation between its primary and secondary windings.

According to the invention, a magnetic structure is provided comprising: an input stage comprising an input yoke and at least two input cores, an output stage comprising an output yoke and at least two cores, and at least one intermediate stage comprising at least two cores, the input stage being magnetically coupled to one of the at least one intermediate stage, the output stage being magnetically coupled to one of the at least one intermediate stage, the magnetic structure being characterized by gaps with low magnetic permeability and high electrical voltage withstand capability, wherein the gaps provide magnetic coupling between the stages, poles, which expand the cross-area of the cores by having a larger cross-sectional area than the cores, wherein the poles from adjacent stages are provided on opposing sides of the gaps, thereby providing magnetic coupling across the gaps, windings provided on the cores of the input stage and adapted to take ac power from sources on ground potential and send it to the output stage, windings provided on the cores of the output stage and adapted to receive ac power from the input stage and provide it to power conditioning equipment to supply auxiliary power to equipment connected to high potential relative ground, and windings provided on the cores of the at least one intermediate stage and connected to capacitors, which provide distributed magnetizing current to the magnetic structure.

In a preferred embodiment, the low magnetic permeability is a relative magnetic permeability less than 10, preferably less than 2.

In a preferred embodiment, the high electrical voltage withstand capability is an above 5 kV/mm. This means that the total electrical voltage withstand capability typically will be in the range of 50-100 kV.

In a preferred embodiment, a plurality of intermediate stages is provided, wherein all intermediate stages are magnetically coupled between themselves.

In a preferred embodiment, the cores, windings, poles and capacitors for each stage are encapsulated in a metallic container or a container having a conducting surface, i.e., a “Faraday cage”.

In a preferred embodiment, all the stage containers are stacked in a tube filled with insulating material, liquid of casted polymeric insulation. The stage containers are preferably stacked in a tube which is filled with insulated material, liquid or casted polymeric insulation, preferably packed in a metallic enclosure is connected to ground potential (“dead-tank”).

In a preferred embodiment, there are two core legs in each stage. Alternatively, there are three core legs in each stage.

In a preferred embodiment, the input and output stages are provided with series compensating capacitors.

In a preferred embodiment, the input stage is powered from a VSC taking power from a de supply on ground potential, preferably from a station battery in a switch-yard.

In a preferred embodiment, the output stage feeds a passive rectifier or alternatively a VSC, which provides a direct voltage to be used as an auxiliary supply for the equipment on high potential.

In a preferred embodiment, several intermediate stages are provided with additional windings to feed several VSC conditioning apparatus to provide auxiliary power supply to several series-connected modules.

In a preferred embodiment, the gaps are 1-2 millimeters.

### BRIEF DESCRIPTION OF DRAWINGS

The invention is now described, by way of example, with reference to the accompanying drawings, in which:

FIG. 1 shows a conventional two-winding transformer with a ferromagnetic core, which passes through both primary and secondary windings.

FIG. 2 shows a gapped transformer with separate magnetic cores halves through the input and output windings. The magnetic core halves are electrically insulated but magnetically coupled through the gap.

FIG. 3 shows a magnetic core arrangement where each core leg has poles that expand the cross-area of the leg at the ends facing the gap.

FIG. 4 shows a magnetic core arrangement, which includes several gaps.

FIG. 5 shows a magnetic core arrangement with several gaps, where each core between the input and output core is provided by a winding that is connected to a capacitor. Furthermore, the input and output windings are provided by series capacitors.

FIG. 6 illustrates one principle to encapsulate each stage of the magnetic structure in a separate “Faraday cage” and to put all cages in a tube, which provides sufficient clearing distance and creepage length.

FIG. 7 shows another principle to encapsulate the magnetic structure with windings and capacitors. In this case the complete structure is cast in polymeric material or placed in liquid oil in a tube.

FIG. 8 illustrates another principle to encapsulate the magnetic structure in “Faraday cages” and place them in a grounded metallic encapsulation (“dead-tank”). The insulating material may be cast polymeric material or liquid oil.

FIGS. 9a and 9b show alternative electrical interfacing approaches of the magnetic structure.

FIG. 10 illustrates a magnetic structure having several outputs to supply auxiliary power to equipment consisting of many series-connected modules.

FIG. 11 shows a magnetic structure with three legs.

FIG. 12 illustrates electrical connection and interfacing equipment for a three-phase auxiliary power supply.

### DESCRIPTION OF EMBODIMENTS

In the following, a detailed description of a magnetic structure according to the invention will be described. In this description, references to directions, such as “up”, refer to what is shown in the figures.

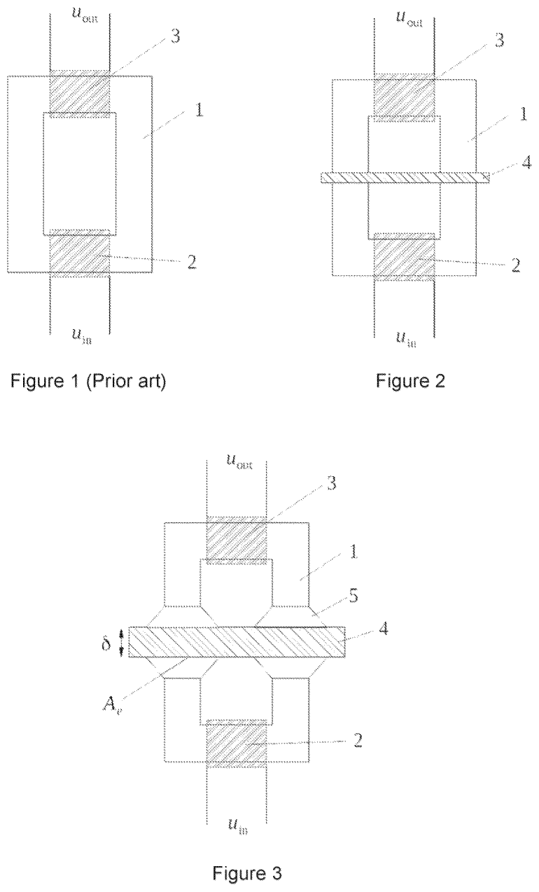

FIG. 1 illustrates a conventional gap-less two-winding transformer having a magnetic core 1, which passes through both primary and secondary windings 2 and 3 respectively. The windings are insulated relative the core and each other to withstand a specified voltage stress, which typically is in the same magnitude of order as the intended operating voltages.

FIG. 2 depicts an arrangement having a magnetic core 1, which passes through both primary and secondary windings 2 and 3 respectively, and wherein a gap 4, filled by insulating material has been inserted into the magnetic structure to extend the voltage withstand capability between the input and output voltages.

However, only small gaps, preferably 1-10 millimeters, more preferably 1-5 millimeters, even more preferably 1-2 millimeters, may be inserted before the magnetizing current of the transformer reaches levels making the active power transfer very ineffective. The gaps have low magnetic permeability and high electrical voltage withstand capability so that they provide magnetic coupling between the poles. In a preferred embodiment, the low magnetic permeability is a relative magnetic permeability less than 10, preferably less than 2. The high electrical voltage withstand capability is an electrical voltage withstand capability above 5 kV/mm.

FIG. 3 shows an arrangement where soft-magnetic poles 5 have been inserted to magnify the cross-area, Ae, of the magnetic core facing the gap 4. The permeance of the gap is given by the ratio, Ae/o, between the cross-area of the core and the gap length, o. Therefore, the gap length may be increased proportionally when the cross section is expanded, without changing the characteristics of the magnetic structure. The extended gap 4 allows more insulating material to be used to separate the input and output windings, 2 and 3 respectively, thereby increasing the voltage withstand capability between the input and output windings.

The design described with reference to FIG. 3 makes it possible to widen the gaps 4 in the transformer core, up to an order of magnitude relative what is practical without the pole arrangement.

Numerous applications in power transmission systems would benefit from getting auxiliary power supply to equipment on high potential from the grounded battery-supported station de battery, which is available in the switchyard. The insulation between input and output windings for such equipment may be tested with “Basic Lightning Impulse” or “Basic Switching Impulse” with amplitudes up into the megavolt range.

The necessary total gap length for insulating material providing several hundred kilovolts withstand capability is many centimetres. Such gap lengths cannot be realized in a conventional gapped ferrite core rated for a few kilowatts.

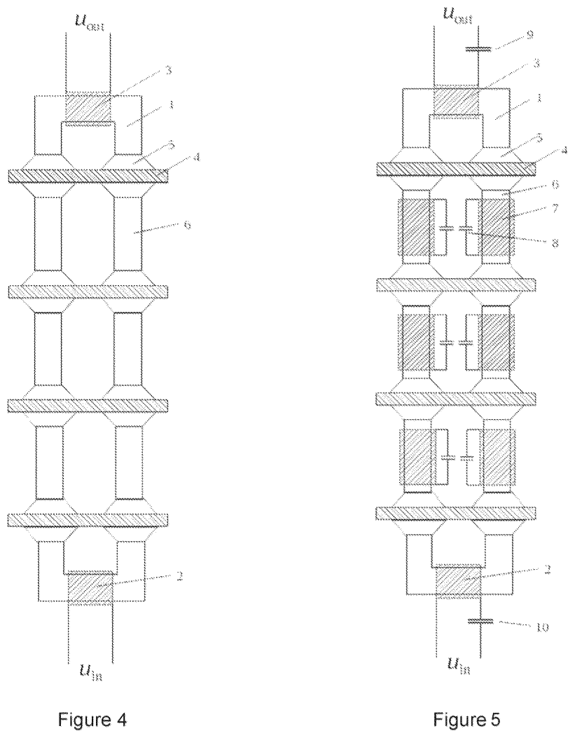

FIG. 4 illustrates a magnetic structure containing several gaps 4, which utilize the principle shown in FIG. 3 to allow an “extended” gap. The magnetic flux is conducted by intermediate cores 6 between the gaps. This structure can be designed with sufficient number of gaps to provide the relevant voltage withstand capability for power supply to equipment at high potential.

The capacitance between the output winding 3 and the input winding 2 becomes quite small for the arrangement according to FIG. 4. This means that quite small transient currents will be caused by fast surge voltages on the winding connected to high potential. However, the total gap length in the arrangement in the magnetic structure in FIG. 4 becomes very long, which means that the magnetic coupling between the input and output windings becomes very low.

Therefore, an enormous magnetizing current must be provided from the input (and possibly the output) winding to force the magnetic flux to flow through the whole core arrangement.

FIG. 5 shows an arrangement where the intermediate cores 6 carry windings 7, which are connected to capacitors 8. The self-inductance of each winding 7 forms a resonance circuit together with the connected capacitor 8. The resonance frequency may be denoted ω0. When the resonance circuit becomes excited with a frequency lower than ω0 the induced voltage will cause the capacitor 8 to supply capacitive current into the magnetic structure, thereby further magnetizing the winding 7. In this way the necessary magnetizing current can be delivered by the distributed capacitors along the magnetic structure.

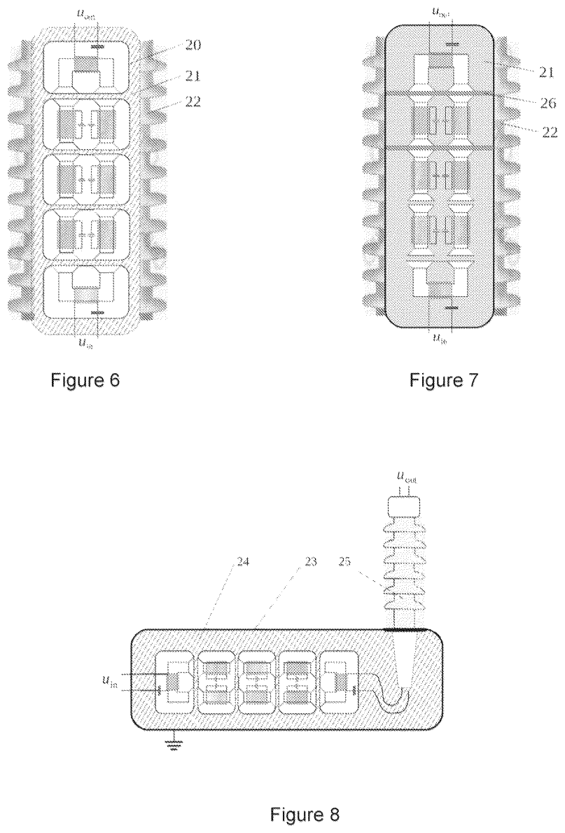

In a preferred embodiment all equipment between each pair of gaps in FIG. 6 may be located inside containers 20, where each container is covered by a conducting layer forming an equipotential shell (“Faraday cage”) as illustrated in FIG. 6.

In a preferred embodiment, illustrated in FIG. 6, the containers 20 may be placed in a tube 22 filled with insulating material 21. The tube 22 provides the external insulation and creepage distance. The insulating material 21 may be a liquid, like oil, or casted polymeric material, like epoxy or polyurethane or any other polymeric insulating material. The insulating material 21 fills the gaps between the containers 20 and forms the insulation between them.

In another preferred embodiment, shown in FIG. 7, the magnetic structure shown in FIG. 5 is placed directly in a tube 20, which is totally filled by insulating material 21, liquid or cast polymeric material. The insulation in the gaps separating the poles is formed by the insulating material 21, as illustrated in the lower gaps in FIG. 7, or may contain insulating discs or plates of solid material 26, as shown in the upper gaps in FIG. 7. The tube may have external skirts 22 to achieve sufficient creepage distance.

In another preferred embodiment the stack of containers 20 is placed in a metal container 23 filled by insulating material like oil, or gas like SF6, or any solid insulating material 24, connected to ground potential (“dead-tank”) as shown in FIG. 8. The high voltage output connection then may be taken out of the container through a bushing 25.

Alternatively, the magnetic structure directly, i.e., without containers 20, may be placed in a metallic enclosure like the one shown in FIG. 8.

Typically, the high potential connected at the voltage output terminal relative ground will automatically share between the containers 20, but in some cases, specifically when high direct voltage is applied, it may be necessary to support the voltage sharing, by providing additional means like high-ohmic resistors or conductive varnish.

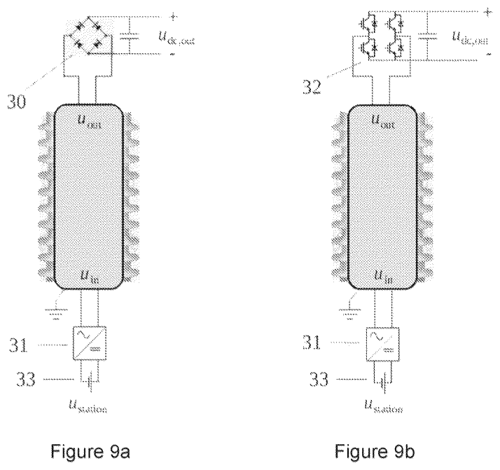

In a preferred embodiment the transformer arrangement described with reference to FIG. 5 is used to provide auxiliary power in the form of direct voltage at a given level to the load at high potential. In this case the output terminal may be connected to a rectifier 30, which utilizes passive diodes to convert the voltage uₒᵤₜ into a direct voltage as shown in FIG. 9a. However, a better control of the output direct voltage may be obtained using more sophisticated ac/dc-converter types. e.g., based on VSC (voltage source converter) technology 32. FIG. 9b illustrates this alternative.

In a preferred embodiment, shown in FIGS. 9a and 9b, power from a direct voltage source, e.g. a battery-backed station power supply 33 in a switchyard, is used to feed a power electronic dc/ac converter 31 providing ac voltage uᵢₙ to the input terminal of the transformer arrangement according to FIG. 5. Typically, the dc/ac converter is of VSC type. Such a converter may operate to provide an input voltage uᵢₙ with constant amplitude from a varying direct voltage, which is normally the case in a station auxiliary power supply in a switchyard.

When converters of VSC type are used both at ground level as well as high potential synchronization signals may be communicated between the VSCs on an optical fibre or by radio.

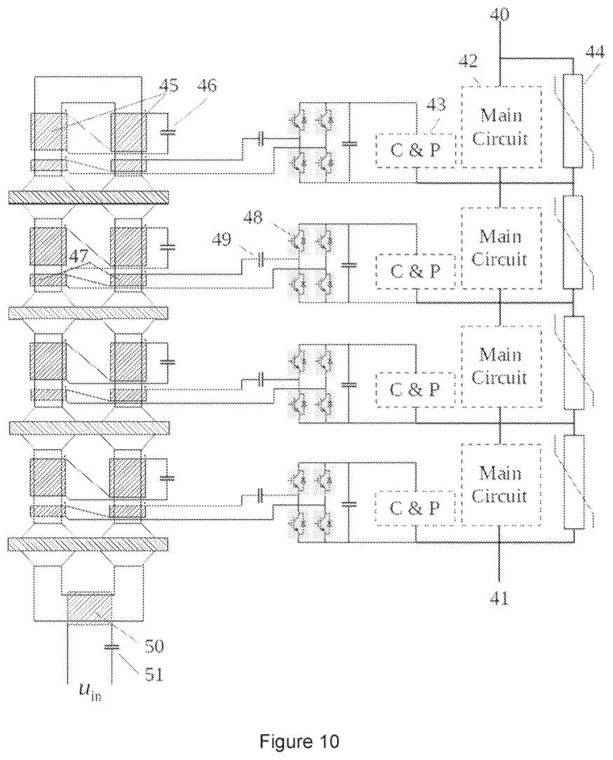

FIG. 10 illustrates an apparatus, which consists of several series connected modules, each one having a “Main Circuit” typically handling high voltage (tens of kilovolts), and a “Control and Protection” device marked C&P, which comprises low-power functions for control, protection and other service functions like actuators for local switchgear, cooling equipment etc. The C&P requires local auxiliary power supply. The voltage across series-connected module is limited by a local Metal Oxide Varistor, MOV 44.

The apparatus is connected to high potential at 40 and 41 in FIG. 10.

A structure like the one illustrated in FIG. 5 may be used to distribute auxiliary power to the different modules by an arrangement illustrated in FIG. 10, if each stage in the transformer has an insulation level that correspond to that defined by the MOV.

The windings 45 at each level are connected in series and connected to a capacitor 46, which provides magnetizing current to the magnetic structure. Another pair of windings 47 is added on the magnetic cores and the windings are also series connected. Their output is connected to a small VSC 48 through a series capacitor 49. The de link in the VSC provides auxiliary power to the C&P device 43.

The whole arrangement takes power from the ac voltage uᵢₙ to the winding 50 through series capacitor 51. The voltage uᵢₙ may be provided as the output voltage uₒᵤₜ from another auxiliary power supply according to FIG. 5 from ground.

In another embodiment a transformer, generally designated 60, comprises an input stage 61, an output stage 62, and an intermediate stage 63.

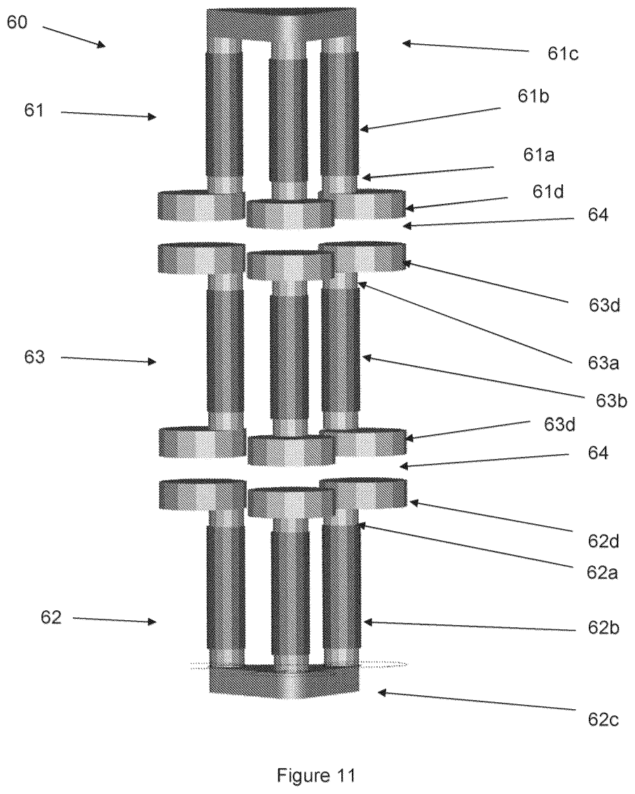

Each stage 61, 62, 63 comprises at least two legs, in the embodiment of FIG. 11, three legs. In the shown embodiment, a single intermediate stage 63 is shown. However, there may be more than one intermediate stage 63 connected in series between the input stage 61 and the output stage 62.

The input stage 61 comprises an input yoke 61c connected to three cores 61a. Each core 61 is surrounded by an input winding 6b and each core 61 has a pole 61d facing a gap 64, which separate the adjacent stages. The gaps 64 are filled by electrically insulating material, such as epoxy or any other suitable polymeric material.

Correspondingly, the output stage 62 comprises an output yoke 62c connected to three cores 62a. Each output core 62 is surrounded by an output winding 62b and each core 62 has a pole 62b facing a gap 64 as in the input stage 61.

The intermediate stage 63, or each intermediate stage in the case more than one are provided, comprises three intermediate cores 63a. Each intermediate core 63a is surrounded by an intermediate winding 63b and each core 63a has two poles 63b, one in each end of the core. Each pole 63b faces a gap 64. In the shown embodiment, the upper gaps 64 face the input stage 61 and the lower gaps 64 face the output stage 62.

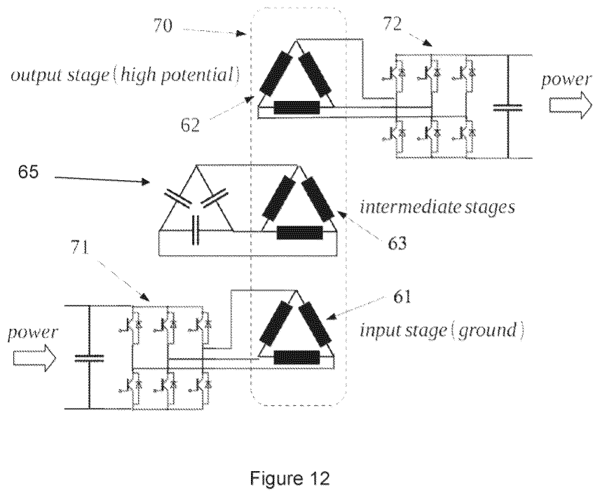

The electrical connection of the windings in FIG. 11 is shown in FIG. 12, where the structure on FIG. 11 is enclosed in the area 70. The structure may comprise several intermediate stages. The input windings 61, the output windings 62 and the intermediate stage windings 63 may be connected in a three-phase fashion such as D-connection, as illustrated in FIG. 12, or in Y-connection. The intermediate stages are connected to capacitor banks 65, which provide distributed magnetizing current to the structure 70.

The input power to the input windings 61 is delivered from VSC 71, which converts de power supplied on ground potential, e.g., from a station auxiliary power supply in a switchyard, into alternating voltage with suitable frequency, which is delivered to the input windings 61. Series capacitors may be inserted in the input connection to the input windings 61 and/or in the output connection from the output windings 62.

The alternating voltage on the output windings may be connected to a VSC 72, which converts the ac power into direct voltage to be used as auxiliary power supply to equipment connected to high potential.

Alternatively, the output windings 62 may be connected to a passive rectifier, which replaces the VSC 72.

We claim:

1. A magnetic structure (60) comprising:
an input stage (61) comprising an input yoke (61c) and at least two input cores (61a),
an output stage (62) comprising an output yoke (62c) and at least two cores (62a), and
at least one intermediate stage (63) comprising at least two cores (63a),
the input stage (61) being magnetically coupled to one of the at least one intermediate stage (63), the output stage (62) being magnetically coupled to one of the at least one intermediate stage (63),
characterized by
gaps (64) with low magnetic permeability and high electrical voltage withstand capability, wherein the gaps (64) provide magnetic coupling between the stages (61, 62, 63),
poles (61d, 62d, 63d), which expand the cross-area of the cores by having a larger cross-sectional area than the cores (61a, 62a, 63a), wherein the poles from adjacent stages are provided on opposing sides of the gaps (64), thereby providing magnetic coupling across the gaps (64),
windings (61b) provided on the cores (61a) of the input stage (61) and adapted to take ac power from sources on ground potential and send it to the output stage (62),
windings (62b) provided on the cores (62a) of the output stage (62) and adapted to receive ac power from the input stage (61) and provide it to power conditioning equipment to supply auxiliary power to equipment connected to high potential relative ground, and
windings (63b) provided on the cores (63a) of the at least one intermediate stage (63) and connected to capacitors (65), which provide distributed magnetizing current to the magnetic structure (60).

2. The magnetic structure (60) according to claim 1, wherein the low magnetic permeability is a relative magnetic permeability less than 10, preferably less than 2.

3. The magnetic structure (60) according to claim 1, wherein the high electrical voltage withstand capability is an electrical voltage withstand capability above 5 kV/mm.

4. The magnetic structure (60) according to claim 1, comprising a plurality of intermediate stages (63), wherein all intermediate stages (63) are magnetically coupled between themselves.

5. The magnetic structure according to claim 1, wherein the cores (61-63), windings (61b, 62b, 63b), poles (61d, 62d, 63d) and capacitors (65) for each stage are encapsulated in a metallic container or a container having a conducting surface.

6. The magnetic structure according to claim 5, where all the containers are stacked in a tube filled with insulating material, liquid of casted polymeric insulation.

7. The magnetic structure according to claim 6, being stacked in a tube which is filled with insulated material, liquid or casted polymeric insulation.

8. The magnetic structure according to claim 5 wherein the metallic enclosure is connected to ground potential.

9. The magnetic structure according to claim 1, having two core legs in each stage (61, 62, 63).

10. The magnetic structure according to claim 1, having three core legs in each stage (61, 62, 63).

11. The magnetic structure according to claim 1, where the input (61) and output (62) stages are provided with series compensating capacitors.

12. The magnetic structure according to claim 1, where the input stage (61) is powered from a VSC (71) taking power from a de supply on ground potential, preferably from a station battery in a switch-yard.

13. The magnetic structure according to claim 1, wherein the output stage (62) feeds a passive rectifier (30), which provides a direct voltage to be used as an auxiliary supply for the equipment on high potential.

14. The magnetic structure according to claim 1, wherein the output stage feeds a VSC (72), which controls and conditions a direct voltage to be used as an auxiliary supply for the equipment on high potential.

15. The magnetic structure according to claim 1, where several intermediate stages (63) are provided with additional windings to feed several VSC conditioning apparatus to provide auxiliary power supply to several series-connected modules.

16. The magnetic structure according to claim 1, wherein the gaps (64) are 1-2 millimeters.
